(19) United States
(12) Patent Application Publication
(10) Pub. No.: US 2024/0353227 A1
(43) Pub. Date: Oct. 24, 2024

(54) METHOD OF BUILDING MAPPING FOR FIRST RESPONDERS

(71) Applicant: GM GLOBAL TECHNOLOGY OPERATIONS LLC, Detroit, MI (US)

(72) Inventors: Matthew E. Gilbert-Eyres, Rochester Hills, MI (US); Russell A. Patenaude, Macomb Township, MI (US); Eric T. Hosey, Royal Oak, MI (US); Matthew Neely, Rochester, MI (US); Adam L. Wright, Livonia, MI (US)

(73) Assignee: GM GLOBAL TECHNOLOGY OPERATIONS LLC, Detroit, MI (US)

(21) Appl. No.: 18/304,538

(22) Filed: Apr. 21, 2023

(51) Int. Cl. G01C 21/20; B64U 10/10; G01C 21/00

(52) U.S. Cl. CPC G01C 21/206; B64U 10/10; G01C 21/383; B64U 2101/30

(57) ABSTRACT

Methods of mapping buildings for first responders, include using a smart device app to identify data related to entrances and exits in the building; storing the data in a centralized location or smart device app; and providing the data from the centralized location to the first responders in emergency situations. The methods may include recognizing patterns of the entrances and exits with the smart device app, the smart device app collects images, such that important objects recognizing in the collected images with the smart device app. A drone may be used to assist in mapping the building and measurements, such that the images collected by the drone are subject to important object recognition. The data to create augmented reality maps that are provided to first responders in emergency situations. Third-party devices may contribute to mapping the building and external factors mapped, including type of access to house, driveway, elevation.

### INTRODUCTION

The present disclosure relates to methods for mapping one or more buildings for use by first responders. Mapping technologies may be used to help first responders in emergency situations. Currently no technologies exist to help map buildings, in particular, to provide common entrances or exits or identify important objects, for first responders.

### SUMMARY

Methods of mapping one or more buildings for first responders, which may be executed by a non-transitory computer-readable storage medium on which is recorded instructions, includes: using a smart device app to identify data related to entrances and exits in the building; storing the data in a centralized location or the smart device app accessible to first responders; and providing the data from the centralized location to the first responders in emergency situations. The methods may include recognizing patterns of the entrances and exits with the smart device app.

The methods may include the smart device app collecting images, such that important objects being recognized in the collected images with the smart device app. The methods may include using a drone to assist in mapping the building and collecting images and measurements of the building via the drone, such that the images collected by the drone are subject to important object recognition.

The methods may include using the data to create augmented reality maps, wherein the augmented reality maps are provided to first responders in emergency situations. The methods may include using a third-party device to contribute to mapping the building, such that the third-party device adds to the building map. The methods may include mapping external factors such as, without limitation, type of access to house, driveway, elevation.

The methods may include collecting data from inside of the building; and allowing a user to edit collected data and remove sensitive data. The methods may include using smart doors and smart locks to integrate with a building profile for easier access by first responders. The methods may include using a third-party device to contribute to mapping the building.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of a system for mapping buildings for use by first responders.

FIG. 2A and FIG. 2B are schematic flow chart diagrams of a method for mapping buildings for first responders.

FIG. 3 is a schematic flow chart diagram of a method for pattern recognition.

### DETAILED DESCRIPTION

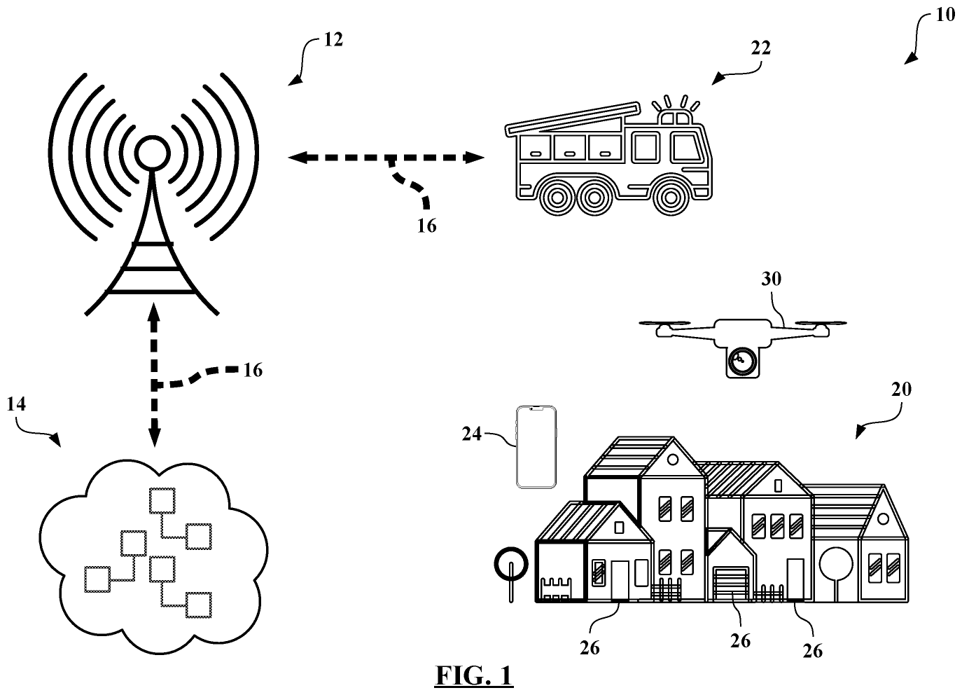

Referring to the drawings, like reference numbers refer to similar components, wherever possible. FIG. 1 schematically illustrates a connectivity network or connectivity system 10. The connectivity system 10 includes numerous components, only some of which are listed herein. A remote or cellular communications system, or cellular network 12, which may be representative of many types of communications protocols, including, without limitation: cellular, satellite, Wi-Fi, Bluetooth, or other communications recognizable to those having ordinary skill in the art.

A centralized location 14 is shown highly schematically, but may be representative of many different structures, clouds, servers, or elements, as will be recognized by skilled artisans. The centralized location 14 represents systems that communicate with some or all of the other systems and/or objects described herein. The centralized location 14 includes numerous controllers.

Several transfer protocols or transfers 16 are schematically illustrated. These transfers 16 may include, without limitation: cellular, Wi-Fi, wired networks, over-the-air (OTA), other transport protocols, including machine to machine (M2M), or other telematics equipment, or other systems recognizable by those having ordinary skill in the art. M2M systems use point-to-point communications between machines, sensors, and hardware over cellular, Wi-Fi, or wired networks.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller is operatively in communication with relevant components of all systems, and recognizable by those having ordinary skill in the art. The controller includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols.

Furthermore, the controller may include, or be in communication with, a plurality of sensors. The controller is configured to execute or implement all control logic or instructions described herein and may be communicating with any sensors described herein or recognizable by skilled artisans. Any of the methods described herein may be executed by one or more controllers.

The connectivity system 10 may be used to execute a method of mapping one or more buildings 20 for first responders, including, without limitation, ambulance, police, or firefighters. The first responders are represented in FIG. 1 by a fire truck 22. The first responders may be provided a building profile in response to emergencies.

The methods include using a smart device 24 having a smart device app to identify data related to, among other things, entrances and exits 26 in the buildings 20. Smart devices 24 include, without limitation, web and/or cellular enables smart phones or tablets, or other recognizable to skilled artisans. Smart device apps include numerous applications run on smart devices 24, as will be recognized by skilled artisans. The entrances and exits 26 may include, without limitation, doors, garage doors, sliding doors, and openable windows within the buildings 20. Note that, depending on the type of building 20, there may be dedicated entrances and dedicated exits. These may also be referred to as access points.

The methods may store the data in the centralized location 14, which is accessible to the first responders. Note that the data may also be stored, without limitation, in one of the smart device 14 and/or the smart device app. Then, during emergency situations, the data is provided from the centralized location 14 to the first responders. Note that, without limitation, the data collected and stored will be subject to data protection and data encryption, as would be recognized by skilled artisans.

In addition to the smart device 24 and the smart device app, the methods may use one or more drones 30 to collect images and measurements of the buildings 20. Additionally, and without limitation, the methods may use a third-party device to contribute to mapping the buildings 20. The third-party device may include, for example and without limitation, a robotic vacuum or another device, or devices, that know areas of the building 20. Additional third-party resources include, without limitation, security cameras, smart doors, and/or garage doors to provide enhanced data to support mapping and pattern recognition.

The drones 30 and the smart device 24 may be using numerous technologies to map the buildings 20. For example, and without limitation, camera images or moving images (video) may be captured, and LIDAR or RADAR may be used. The images captured may be subject to important object recognition. For example, AI may recognize objects, including, without limitation: washing machines, water heaters, gas main or electric shut offs.

The methods described herein do numerous things, only some of which are listed below. The methods may map buildings 20 for access points, such as entrances and exits 26, via drone 30 and/or smart device 24. Log locations of utilities such as main water shutoff, gas shutoff, electrical panel, or other important objects.

The smart device app may use pattern recognition to detect most common entrances and exits 26 points in the building 20 and use pattern recognition to detect most common routes within the building 20. Map external factors such as type of access to house, driveway, and elevation. Map augmented reality (AR) using smart device 24 camera and/or lidar. Overlay AR information to the first responders, such as for use by firefighters during an emergency.

The smart device app may allow users to edit collected data for sensitive data and use smart devices 24 to enhance data for mapping and pattern recognition. Use smart devices, such as, without limitation: smart doors, smart locks, and smart garage doors to work with first responders. This may occur by linking, such as through the centralized location 14, the smart devices to provide access to the first responders and allow opening/closing of the smart devices.

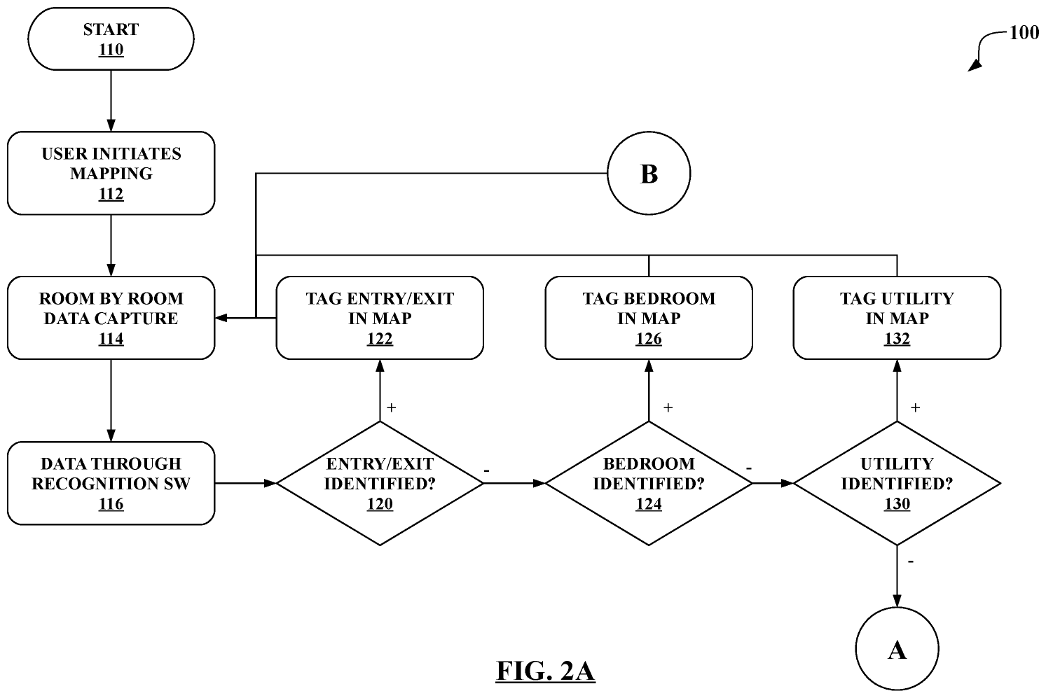

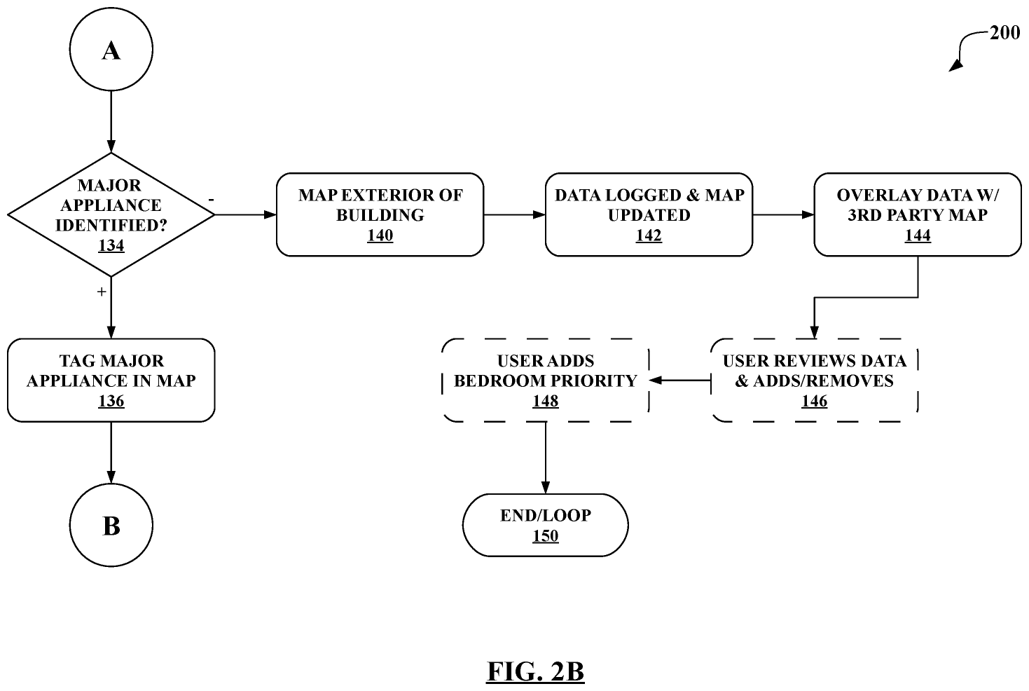

FIGS. 2A and 2B are schematic flow chart diagrams of a method 100 for mapping buildings for first responders. Note that method 100 moves back and forth between FIGS. 2A and 2B.

One or more of the methods described herein may be executed by the controller, including the non-transitory computer-readable storage medium, or other structures or equipment recognizable to skilled artisans. All steps described herein may be optional, in addition to those explicitly stated as such, and all steps described may be reordered or removed.

Step 110: START. At step 110 the method 100 initializes or starts. Method 100 may begin operation when called upon by one or more controllers, may be constantly running, or may be looping iteratively.

Step 112: USER INITIATES MAPPING. At step 112, a user of method 100 initiates the mapping. This may be initiated by, without limitation, the user having the smart device 24 with the smart device app installed thereon. Alternatively, and without limitation, the smart device 24 may initiate the mapping via input from the user.

Step 114: ROOM BY ROOM DATA CAPTURE. At step 114, method 100, the user, the smart device 24, and/or the drone 30 goes room by room to capture data, photos, and/or videos (moving images). Additionally, and without limitation, captured data may include lidar and/or radar, in addition to measurements.

Step 116: DATA THROUGH RECOGNITION SOFTWARE. At step 116, method 100 runs the data captured through one or more recognition software programs. This may help identify different elements within the data. Some of the examples of elements that may be identified by the recognition software are given below, relative to identification and tagging steps, 120-136, but these are not limiting.

Step 120: ENTRY AND/OR EXIT IDENTIFIED? At step 120, method 100 determines whether an entry and/or exit is identified within some portion of the data, such as, without limitation, entrances and exits 26.

Step 122: TAG ENTRY/EXIT IN MAP. If an entrance and/or exit is identified, method 100 tags that entry/exit in the map being generated with, or by, the data. Note that if one of the entrances and exits 26 is blocked, that may also be tagged in the map.

Step 124: BEDROOM IDENTIFIED? At step 124, method 100 determines whether a bedroom is identified within some portion of the data. This may be recognized by identifying items that are normally within bedrooms including, without limitation, beds, closets, and/or dressers.

Step 126: TAG BEDROOM IN MAP. At step 126, when a bedroom is identified, method 100 tags that bedroom in the map being generated with, or by, the data.

Step 130: UTILITY IDENTIFIED? At step 130, method 100 determines whether any utilities are identified. Utilities, or utility locations, include, without limitation: main water shut off, electrical panels, and/or main gas meter shutoff. Additionally, method 100 may automatically detect and catalog additional information related to utilities for first responders such as, without limitation: electrical lines into the building 20, buried or above ground wires, or major appliance locations that could amplify, without limitation, fires, such as gas stove, gas dryer, and the like.

Step 132: TAG UTILITY IN MAP. At step 132, when a utility is identified, method 100 tags that utility in the map being generated with, or by, the data.

Step 134: MAJOR APPLIANCE IDENTIFIED? At step 134, the method 100 determines whether any major appliances are identified within some portion of the data. Major appliances may include, without limitation: washing machines, gas or electric dryers, gas or electric water heaters, gas or electric stoves, or others recognizable by those having ordinary skill in the art.

Step 136: TAG MAJOR APPLIANCE IN MAP. At step 136 when a major appliance is identified, method 100 tags that major appliance in the map being generated with, or by, the data.

Note, importantly, that the identification and tagging steps, 120-136, may loop or repeat, such that all relevant items and/or locations may be identified in the map(s). There may be counters or loops embedded within method 100, such that substantially all identified items and/or locations are tagged before method 100 moves on, or it may simply loop repeatedly until substantially all identified items and/or locations are tagged.

Step 140: MAP EXTERIOR OF BUILDING. At step 140 the user of the smart device 24 or the drone 30 maps the exterior of one or more buildings 20. Note that this may also include taking measurements, such as, without limitation, via lidar/radar or camera data.

Note that the drone 30 and the user can conduct external building 20 mapping, including, without limitation: logging what is outside, such as driveway pitch and/or elevation, type of access to house-walkway, driveway, and/or street. The resulting map(s) generated by the data may be shared with loved ones and with the first responder database to help come up with evacuation plans in case of emergencies.

Step 142: DATA LOGGED AND MAP UPDATED. At step 142, method 100 logs the data and updates the map of the building 20, or buildings 20, likely by storing the data in the centralized location 14.

Step 144: OVERLAY DATA WITH THIRD PARTY MAP. At step 144, method 100 overlays the data with third party map(s). This may include, without limitation, architectural drawings submitted to first responders, such as police and firefighters, or to cities during planning stages for the buildings 20 or during renovation of the buildings 20.

Step 146: USER REVIEWS DATA AND ADDS/REMOVES (OPTIONAL). At step 146, the user may, optionally, review the data and add to the data or remove from the data. For example, and without limitation, sensitive data related to private elements of life within the buildings 20 may be removed from the data or the maps generated thereby.

Step 148: USER ADDS BEDROOM PRIORITY (OPTIONAL). At step 148, the user may, optionally, add priority bedrooms. This may include, for example and without limitation, adding priority of bedrooms with children in them or having handicapped individuals. Additionally, optionally and without limitation, users may tag specific locations, including the important utilities or appliances, within the data or the maps generated thereby, or those locations may be automatically tagged by method 100.

Note that the user may also tag or add chosen access points. Additionally, the user may tag or add common routes, including, without limitation, those that may be quickest or easiest for first responders during emergencies.

Step 150: END/LOOP. At step 150, the method 100 ends or loops. Once the data is used to create one or more maps, the data may be supplied to first responders during emergency situations, as supplemented by the additional methods described herein. Note that those having ordinary skill in the art will recognize situations that may be considered emergency situations, and any situations, including, without limitation, fire emergencies, weather emergencies, or police emergencies discussed herein are not limiting.

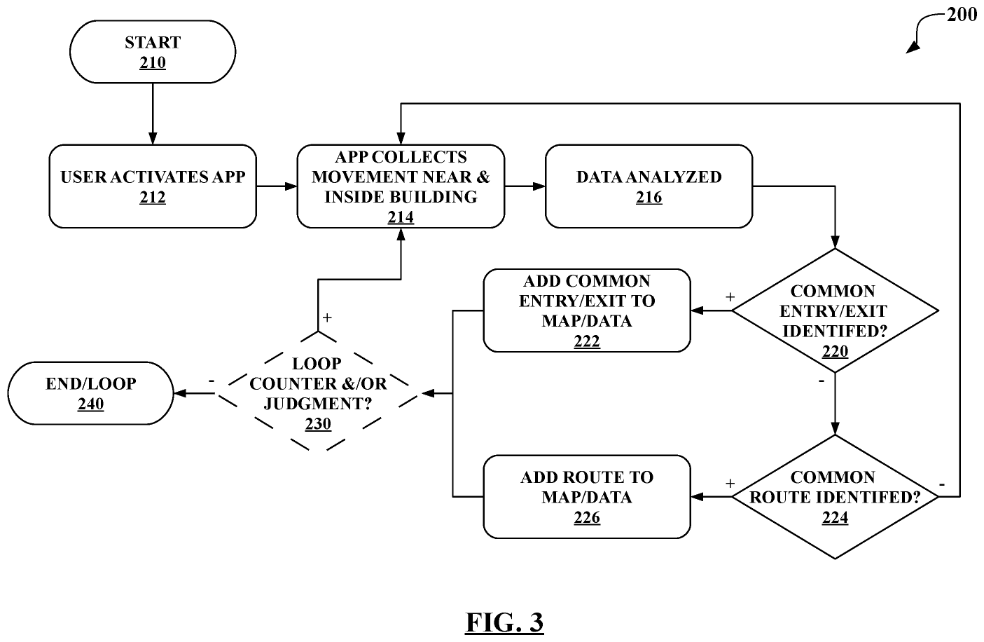

FIG. 3 is a schematic flow chart diagram of a method 200 for pattern recognition. Note that any of the methods described herein may work together, or in conjunction with, method 100.

Step 210: START. At step 210 the method 200 initializes or starts. Method 200 may begin operation when called upon by one or more controllers, may be constantly running, or may be looping iteratively.

Step 212: USER ACTIVATES APP. At step 212, one or more users activates the smart device app on the smart device 24.

Step 214: APP COLLECTS MOVEMENT NEAR AND INSIDE BUILDING. At step 214, method 200 collects movement near and inside of the building 20, or buildings 20, with the app. This movement data can then be used to determine whether, and where, the user tends to move about the building 20.

Step 216: DATA ANALYZED. At step 216, method 200 analyzes the movement data collected in step 214. This allows specific items to be pulled from the data.

Step 220: COMMON ENTRY/EXIT IDENTIFIED? At step 220, method 200 determines whether the user tends to use one entry and/or exit point, which may be any of the entrances and exits 26. For example, and without limitation, this may show that one of the entrances and exits 26 is blocked or obstructed or that the user simply prefers one entry/exit, which may demonstrate that that entry/exit is chosen or easier to use.

Step 222: ADD COMMON ENTRY/EXIT TO MAP/DATA. At step 222, if a common entry/exit is identified, method 200 adds that point to the map and/or data.

Step 224: COMMON ROUTE IDENTIFIED? At step 224, method 200 checks whether the user tends to use any common routes within the building 20. Common routes may demonstrate, without limitation, that there are obstructions in the building 20 and help first responders avoid them.

Step 226: ADD COMMON ROUTE TO MAP/DATA. At step 226, if one or more common routes are identified, method 200 adds that common route to the map and/or data.

Step 230: LOOP COUNTER AND/OR JUDGMENT (OPTIONAL)? At optional step 230, method 200 determines whether a sufficient number of loops have occurred or determines (judges) whether all possible entries/exits and/or routes have been added to the map and/or data. Alternatively, the method may simply proceed to end/loop step 240 and recheck for additional entries/exits and/or common routes and then add those findings. If optional step 230 determines that there are still entries/exits and/or common routes to be added, then method 200 proceeds back to step 214. If not, method 200 proceeds to step 240 to end/loop.

Step 240: END/LOOP. At step 240, the method 200 ends or loops. The end/loop step 240 may then proceed, if necessary, back to the start step 210.

Results of method 200 may be shared with first responders, such as those coming in fire truck 22. Noting the common entrances and exits 26 may alert firefighters to, for example and without limitation, blocked entryways. For example, and without limitation, occupants might never use the front door because it is blocked with boxes, but first responders could identify that a side door is used regularly indicating a likely best path into the house or building 20.

Furthermore, the maps generated with the data collected by the methods described herein may be used with augmented reality (AR). For example, and without limitation, firefighters may use AR on their face shields or goggles during an emergency, such as a fire, when vision will likely be reduced by smoke. This would allow firefighters to “see” their way through building 20, with the use of AR mapping, in spite of visual impairment.

Skilled artisans will recognize features and requirements for the smart device app. Additionally, skilled artisans will recognize the technology required for the smart device 24 and the drone 30 to, without limitation, capture images and moving images, take measurements, and/or lidar/radar. Note that the specific technologies listed herein are not limiting and skilled artisans will recognize additional technologies that may be used with the methods and devices described herein.

The detailed description and the drawings or figures are supportive and descriptive of the subject matter herein. While some of the best modes and other embodiments have been described in detail, various alternative designs, embodiments, and configurations exist.

Furthermore, any examples shown in the drawings or the characteristics of various examples mentioned in the present description are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A method of mapping a building for first responders, comprising:
using a smart device app to identify data related to entrances and exits in the building;
storing the data at least one of a centralized location or the smart device app accessible to first responders; and
providing the data from the centralized location or the smart device app to the first responders in emergency situations.

2. The method of claim 1, further comprising:
recognizing patterns of the entrances and exits with the smart device app.

3. The method of claim 2, wherein the smart device app collects images, and further comprising:
recognizing important objects in the collected images with the smart device app.

4. The method of claim 3, further comprising:
using a drone to assist in mapping the building.

5. The method of claim 4, further comprising:
collecting images and measurements of the building via the drone; and
wherein the images collected by the drone are subject to important object recognition.

6. The method of claim 5, further comprising:
using the data to create augmented reality maps, wherein the augmented reality maps are provided to first responders in emergency situations.

7. The method of claim 6, further comprising:
using a third-party device to contribute to mapping the building, such that the third-party device adds to the building map.

8. The method of claim 7, further comprising:
mapping external factors such as type of access to house, driveway, elevation.

9. The method of claim 8, further comprising:
collecting data from inside of the building; and
allowing a user to edit collected data and remove sensitive data.

10. The method of claim 9, further comprising:
using smart doors and smart locks to integrate with a building profile for easier access by first responders.

11. The method of claim 1, further comprising:
using the data to create augmented reality maps, wherein the augmented reality maps are provided to first responders in emergency situations.

12. The method of claim 1, further comprising:
using a third-party device to contribute to mapping the building.

13. A non-transitory computer-readable storage medium on which is recorded instructions, wherein execution of the instructions by a processor causes the processor to:
use a smart device app to identify data related to entrances and exits in a building;
store the data in a centralized location or the smart device app accessible to first responders, wherein the stored data in the centralized location is encrypted; and
provide the data from the centralized location or the smart device app to the first responders in emergency situations.

14. The non-transitory computer-readable storage medium of claim 13, wherein execution of the instructions by the processor causes the processor to:
recognize patterns of the entrances and exits with the smart device app and adding that data to the centralized location.

15. The non-transitory computer-readable storage medium of claim 14, wherein execution of the instructions by the processor causes the processor to:
use a drone to assist in mapping the building;
wherein the drone collects images and measurements of the building; and
wherein the images collected by the drone are subject to important object recognition.

16. The non-transitory computer-readable storage of claim 15, wherein execution of the instructions by the processor causes the processor to:
collect images with the smart device app;
identify data related to the entrances and exits in the building using the images collected by the smart device app; and
wherein the images collected by the smart device app are subject to important object recognition.

17. A method of mapping a building for first responders, comprising:
using a smart device app to identify data related to entrances and exits in the building;
storing the data in a centralized location accessible to first responders; and
providing the data from the centralized location to the first responders in emergency situations;
recognizing patterns of the entrances and exits with the smart device app;
recognizing important objects with the smart device app;
using a third-party device to contribute to mapping the building; and
using the data to create augmented reality maps, wherein the augmented reality maps are provided to first responders in emergency situations.

18. The method of claim 17, further comprising:
using a drone to assist in mapping the building;
wherein the drone collects images and measurements of the building; and
wherein the images collected by the drone are subject to important object recognition.

19. The method of claim 18, further comprising:
collecting data from inside of the building:
allowing a user to edit collected data and remove sensitive data; and
using smart doors and smart locks to integrate with a building profile for easier access by first responders.

20. The method of claim 19, wherein the important objects are recognized via software recognition.
